(19) United States
(12) Patent Application Publication
(10) Pub. No.: US 2006/0159894 A1
(43) Pub. Date: Jul. 20, 2006

(54) Preparation process of fabric forming three-dimentional pattern

(76) Inventors: Takuya Suehiro, Fukui-shi (JP); Takahiro Kosaka, Fukui-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/326,382

(22) Filed: Jan. 6, 2006

(30) Foreign Application Priority Data
Jan. 14, 2005 (JP) 2005-7201

(51) Int. Cl. B32B 5/02; B32B 9/00; B32B 3/00

(52) U.S. Cl. 428/195.1; 347/1; 442/59

(57) ABSTRACT

The present invention provides a preparation process of a fabric forming a fine three-dimensional pattern in which a fiber discharging area and its peripheral of an unprocessed area of fiber discharging are separated distinctively, which does not depend on a kind of a fabric used and a thickness of thereof, thickness of a thread and a way of twisting thereof, and weaving and knitting. The present invention relates to a preparation process of a fabric forming a three-dimensional pattern comprising a step of imparting an ink containing alkaline fiber discharging agent to the fabric in a fiber discharging area by means of an ink jet system, and a step of imparting an ink containing salt of which pH is 3.0 to 8.0 when dissolved into water to an area excluding said fiber discharging area by means of the ink jet system.

### BACKGROUND OF THE INVENTION

The present invention relates to a preparation process of a fabric forming a three-dimensional pattern and, specifically, a preparation process of a fabric forming a three-dimensional pattern comprising a step of imparting a discharging agent which dissolves, shrinks and decomposes a fiber to the fabric by using an ink jet system.

A method in which a chemical formed as an ink is applied and a fiber constituting the fabric is dissolved, shrinked and decomposed in ink jet printing to form a three-dimensional pattern having unevenness on the fabric, and a method in which only one kind of fiber in a composite material using at least 2 kinds of fibers is dissolved, shrinked or decomposed to express so-called opal-like transparency on the fabric are known. Used chemicals and process conditions of these process methods are different depending on other conditions such as a kind of fiber in which dissolving, shrinking and decomposing processes are carried out or composition of a thread and a fabric, thus, in practice, various processes are existed. A method employing a fiber shrinking agent is described, for example, in JP-A-10-298863.

Among those, a process utilizing fiber decomposition by an agent whose main component is an alkali for a fabric comprising particularly polyester fibers (including cation dyeable polyester fiber. Hereinafter referred to as PET fiber) is widely available in general. Examples of representative processed fabrics of PET fibers are a pile fabric of PET fibers and composite materials; the former forms a raised fabric having unevenness on the surface by decomposition removing raised fibers, and the latter forms an opal pattern by dissolving, shrinking, and decomposing only PET fibers and remaining other fibers.

Examples of the agent whose main component is alkali are alkali salts represented by sodium hydroxide and potassium hydroxide, or solutions containing these alkali salts, and an alkali hydrolysis accelerator (loss in weight accelerator) such as a cation surfactant may be used at the same time.

A specific method comprises steps of imparting the agent whose main component is alkali and a fiber decomposing agent containing a loss in weight accelerator if necessary to an area discharging-processed on a PET fiber fabric, and then treating with heat by a steamer, and subsequently removing fibers in the area by washing and carrying out caustic treatment process. By these steps, a pile fabric having a three-dimensional pattern of unevenness and a composite fabric having a opal-like pattern can be obtained since fibers in an area of applying a fiber decomposing agent are only decomposed and removed, and fibers in an area of not applying are remained on the fabric.

Also, for a PET fiber in an area where fiber decomposition does not occur, a variety of patterns are expressed since coloration process by coloring inks can be conducted at the same time as fiber discharging process according to the ink jet system.

By the way, a problem when the ink jet system is used and a fiber discharging agent formed as an ink is imparted to a fabric is easiness of ink blurring, though the problem is general in the printing field utilizing the ink jet system without limiting to this fiber discharging process. When the fiber discharging agent formed as an ink is imparted on the fabric with the ink jet system, the imparted fiber discharging agent along with a solvent of an ink blur in parallel with a direction of fibers of the fabric or a direction of texture. As a result, an area where discharging process is carried out tends to enlarge easily more than a desired area.

Regarding the degree of this blur, due to contributing to conditions such as viscosity of a solvent used at forming a fiber discharging agent as an ink, the degree of blur tends to decrease by increasing the viscosity of ink. However, in case of the ink jet system, there is the upper viscosity limit of ink by discharging conditions of each ink jet printing machine. Also, the degree of blur is caused by a kind of a fabric in use and a thickness of thereof, thickness of a thread and a way of twisting thereof, and weaving and knitting, and for each of them, improvement in a certain degree is possible by changing a construction of an ink receiving layer. However, at dealing with various kinds of fabrics, it is very difficult to find a perfect condition by considering each case of blur at each time, and thus it is very difficult to inhibit an area of blur minutely. Further, controlling the area of blur becomes more difficult since high-temperature steam at treating with heat by the above described steamer is contributed for enlargement of a fiber discharging area. Due to these causes, expressions of discharge printing patterns are very difficult in general even though differences exists by tissues of a fabric, a kind of a thread in use, process conditions and a thickness of a thread due to these causes.

Also, when colors are expressed by employing coloring inks for an unprocessed area of fiber discharging on the same fabric, at the same time as the fiber discharge printing, a dye having resistance against alkali, which is main component of a fiber discharging agent, must be employed since there is a possibility of accompanying color change of dye by alkali in an area adjacent to a fiber discharging area or lowering of a concentration. In this manner, when coloring on an unprocessed area of fiber discharging, a range of color variations becomes narrow since there is a limitation for dyes which can be used. Further, since an particularly large amount of ink, namely, an ink containing a fiber discharging agent and a coloring ink are imparted on the boundary between fiber discharging part and the color expressing part, an amount of a solvent for an ink which causes blur becomes extremely large. Therefore, there is a problem that the boundary between fiber discharging part and the unprocessed part of fiber discharging (color expressing part) easily strays toward an area of an unprocessed part of fiber discharging and the boundary becomes unclear.

In the three-dimensional pattern forming technology utilizing the fiber discharge printing, fineness of the three-dimensional pattern is required and technical development satisfying this requirement is desired.

### SUMMARY OF THE INVENTION

An object of the present invention is to provide a preparation process of a fabric forming a fine three-dimensional pattern in which a fiber discharging area and its peripheral of an unprocessed area of fiber discharging are separated distinctively, which does not depend on a kind of a fabric used and a thickness of thereof, thickness of a thread and a way of twisting thereof, and weaving and knitting.

Namely, the present invention relates to a preparation process of a fabric forming a three-dimensional pattern comprising a step of imparting an ink containing alkaline fiber discharging agent to the fabric in a fiber discharging area by means of an ink jet system, and a step of imparting an ink containing salt of which pH is 3.0 to 8.0 when dissolved into water to an area excluding said fiber discharging area by means of the ink jet system.

The present invention further preferably comprises a step of imparting an ink containing a coloring agent by means of an ink jet system.

The alkaline fiber discharging agent is preferably guanidine carbonate.

The fabric preferably comprises polyester fibers.

Also, the present invention relates to the fabric forming a three-dimensional pattern which is obtained by the preparation process described above.

### BRIEF DESCRIPTION OF THE DRAWING

FIG. 1 is a diagram showing a pattern for printing in Examples of the present invention.

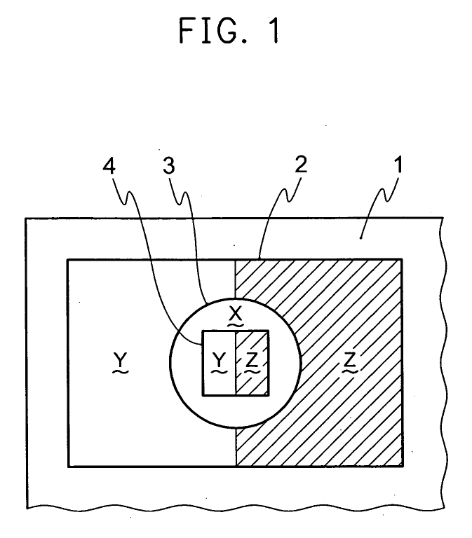

### DETAILED DESCRIPTION

The present invention is a preparation process of a fabric forming a three-dimensional pattern comprising a step of imparting an ink containing alkaline fiber discharging agent to the fabric in a fiber discharging area by means of an ink jet system, and a step of imparting an ink containing salt of which pH is 3.0 to 8.0 when dissolved into water to an area excluding said fiber discharging area by means of the ink jet system.

A fabric used in the present invention is not particularly limited as long as the fabric comprises fibers discharged by an alkaline fiber discharging agent. Specifically, it is preferable to contain a polyester fiber comprising polyethylene terephthalate etc and polyester fibers such as a cation dyeable polyester fiber of the normal pressure type or the high pressure type in the viewpoint of various uses such as sport clothes, fashion clothes, inner clothes, automobile interior materials and advertising curtains since strength, weather resistance and chemical resistance are excellent. Examples are a pile fabric made of 100% of polyester, a composite fabric of a polyester fiber/a nylon fiber, and a composite fabric a polyester fiber/cotton.

When polyester fibers are contained, the fineness of each fiber is preferably at most 3 decitex and more preferably at most 2 decitex. The lower limit is preferably 0.1 decitex and more preferably 0.7 decitex. When the fineness of each fiber is more than 3 decitex, it may be difficult to decompose and remove completely, and it tends to be a problem visually, tactily or functionally. Also, the total fineness is at most 170 decitex and preferably at most 110 decitex. The lower limit of the total fineness is preferably 22 decitex and more preferably 56 decitex. When the total fineness is more than 170 decitex, texture of the fabric becomes hard and, subsequently, there is possibility of occurring fluctuation and defect in decomposition of polyester fibers.

In a fabric used in the present invention, a discharged fiber is preferably contained in an amount of at least 25% by weight and more preferably 25 to 80% by weight. When the discharged fiber is less than 25% by weight, it tends that a three-dimensional pattern can not be expressed apparently.

When composite fabrics are used, those different kinds of fabric are combined by a method such as blending spinning, blended yarn, combined twisting, combined weaving, and combined knitting.

Examples of fabrics used in the present invention are knit fabric, woven fabric, and non-woven fabric, but are not particularly limited. Examples of woven fabrics are plain weaving, diagonal weaving, and satin weaving. Examples of knitting fabrics are weft knitting such as plain knitting, rubber knitting and pearl knitting, and warp knitting such as tricot knitting, code knitting, atlas knitting, chain knitting and inlay knitting. Among those, a reversible knitted fabric in which one side of the fabric is mainly constituted with a polyester fiber which is discharged, and the other side of the fabric is mainly constituted with a fiber which is not discharged is preferable in a viewpoint that a large variety of three-dimensional patterns can be formed. Namely, the knitted fabric is constituted with a layer comprising a polyester fiber and a layer comprising a nylon fiber. As for a means of forming a reversible knitted fabric, known methods can be used and are not limited, but particularly, plating method (also referred to as plated stitch) is preferable in viewpoints of being excellent in maintaining strength and less generation of pilling due to abrasion by washing etc. As for the shape of the fabric, a raised fabric is preferable in the viewpoint of excellent texture. The raised fabric is referred to a fabric having a raised fiber, wherein a base fabric comprises a woven-knit fabric or an unwoven fabric. The raised fiber is also called pile, thus, a raised fabric is called a pile fabric.

The thickness is preferably at most 5 mm, and more preferably at most 3 mm. The lower limit is preferably 0.5 mm and more preferably 1 mm. When the thickness is more than 5 mm, permeability of an ink discharging a fiber, which is described later, tends to fluctuate easily, and discharging a fiber tends to be insufficient. When less than 0.5 mm, it tends to be difficult in clearly expressing a part having a three-dimensional pattern visually and tactily.

The above described alkali fiber discharge agent is preferably an alkali showing at least pH 10 in a state of an aqueous solution. When pH is lower than 10, fiber discharging can not be applied, or the degree of processing is extremely week and it tends to become incomplete processing state. Specific examples are weak acid guanidine salts, phenols, alcohols, metal hydroxides such as sodium hydroxide and potassium hydroxide and alkali-earth metal hydroxides. Among those, sodium hydroxide, potassium hydroxide and weak acid guanidine salts are preferable, and weak acid guanidine salts are further preferable, considering that they allow a large unevenness effect to be obtained, and are excellent in terms of environment and safety. Among those, compared with other strong alkali such as caustic soda, pH of a solution is low of 10 to 13, particularly guanidine carbonate is preferable in viewpoint of safety of working, difficulty of corrosion of devices, and small effect on coloring agents in use when coloring a fiber. The fiber is decomposed by guanidine carbonate for the reason that it is assumed that guanidine carbonate changes into strong alkali by decomposing to urea and ammonia in a step of heat treatment conducted after imparting this guanidine carbonate.

Also, the fiber discharging agent is dissolved into water to carry out a treatment of state of an ink, considering that this allows stable discharge for a long period of time. A concentration of the fiber discharging agent is preferably in a range of 10 to 35% by weight, and further preferably in a range of 15 to 30% by weight. When less than 10% by weight, sufficient unevenness effect does not tend to be obtained, and adversely when more than 35% by weight, the amount of a fiber decomposing agent that is dissolved in water becomes close to its limit, causing nozzle clogging when deposition product occurs, and it tends to become impossible to maintain stable discharge for a long period of time.

An ink containing a salt whose pH is 3.0 to 8.0 when dissolved into water used in the present invention (hereinafter referred to as fiber discharge inhibiting ink) provides an acid substance or acid ions which neutralize the alkaline fiber discharging agent, and inhibits discharging, which is caused by the fiber discharging agent. The salt contained in the fiber discharge inhibiting ink has pH in a range of 3.0 to 8.0 when dissolved into water and shows neutral or weak acidulous. At this time, the pH is preferably in a range of 3.0 to 8.0 in a concentration of the salt used for an ink of 10 to 50% by weight, as described later. The pH is more preferably in a range of 3.0 to 8.0 in the concentration of 10% by weight. Examples of the salt are ammonium sulphate, magnesium sulphate, and sodium chloride. Among those, salts generating minus ions of strong acids such as sulphate ion, nitrate ion, and chlorine ion when ionizing are preferable, and ammonium sulphate and magnesium sulphate are more preferable. Further, ammonium sulphate is more preferable. Ph is preferably 4.5 to 7.5. When pH is less than 3.0, deterioration of a surface of a fiber tend to occur easily, and there is a possibility to generate damages on facility, and when more than 8.0, sufficient fiber discharge inhibiting effect can not be obtained.

A concentration of the salt is preferably in a range of 10 to 50% by weight, and more preferably in a range of 20 to 40% by weight. When the concentration is less than 10% by weight, sufficient fiber discharge inhibiting effect tends not to be obtained. When more than 50% by weight, the amount of the salt that is dissolved in water becomes close to its limit, causing nozzle clogging when deposition product occurs, and it tends to become impossible to maintain stable discharge for a long period of time.

Viscosity of an ink containing the fiber discharging agent (hereinafter referred to as a fiber discharging ink) and fiber discharge inhibiting ink is preferably 1 to 10 cps, and more preferably 1 to 5 cps at 25° C. When the viscosity is less than 1 cps, the discharged ink droplets tend to burst in the air, deteriorating the sharpness of the three-dimensional pattern, while when the viscosity is more than 10 cps, discharge of ink from the nozzle tends to become difficult due to high viscosity.

For the fiber discharging ink and the fiber discharge inhibiting ink, it is preferable to make it contain urea, in order to stably dissolve it in water. Urea is optimal because it slightly affects viscosity and surface tension, which are important factors for the ink for an ink jet. It is preferable for the content of urea to be in a range from 0.1% by weight to 10% by weight, and it is more preferable for the content to be in a range from 0.5% by weight to 5% by weight. In the case where the content of urea is lower than 0.1% by weight, it does not have sufficient effect as a solubilizer, and thus, it tends to cause nozzle clogging, while in the case where the content exceeds 10% by weight, three-dimensional patterning of a fabric, which is the original object of the invention, tends to become insufficient.

Furthermore, it is desirable to contain at least one type selected from a group consisting of polyalcohol, polyalcohol derivatives and surfactants to which ethylene oxide is added, considering that air clogging of the nozzle can be prevented by using such an ink. It is preferable for the content thereof to be in a range from 0.1% by weight to 10% by weight, and it is more preferable for the content to be in a range from 0.5% by weight to 5% by weight. In the case where the content is lower than 0.1% by weight, the effect of preventing air clogging of the nozzle becomes low, and an ink that easily causes air clogging tends to be obtained, while in the case where the content exceeds 10% by weight, the ink has a high viscosity, and discharge from the nozzle tends to become difficult.

Glycerin, diethylene glycol, diethylene glycol monomethyl ether, diethylene glycol monobutyl ether, triethylene glycol, triethylene glycol dimethyl ether, triethylene glycol monomethyl ether, propylene glycol, propylene glycol monomethyl ether, dipropylene glycol, tripropylene glycol, trimethylene glycol, polyethylene glycol, and polyethylene glycol dimethyl ether, for example, can be cited as the polyalcohol and the polyalcohol derivatives that can be utilized according to the present invention.

An ethylene oxide adduct of nonionic and cationic surfactants are preferable as surfactants that can be utilized according to the present invention. This is because there is a risk that anionic surfactants may cause a problem in terms of compatibility with a fiber discharging agent and foamability.

Ether type nonionic surfactants, such as polyoxyethylene alkyl ether, ether ester type nonionic surfactants, such as polyoxyethylene glycerin fatty acid ester, ester type nonionic surfactants, such as polyethylene glycol fatty acid ester, and the like can be cited as the ethylene oxide adduct of nonionic surfactants.

In addition, an ethylene oxide adduct of aliphatic amine salts, aliphatic quaternary ammonium salts and the like can be cited as the ethylene oxide adduct of cationic surfactants.

Among those, propylene glycol is more preferable, considering that it is excellent in terms of safety of working. In addition, the ethylene oxide adduct of aliphatic quaternary ammonium salts is more preferable, considering that its stability in alkaline solution is high.

In addition, it is preferable for the surfactants to have a low viscosity, where the number average molecular weight is at most 5000. In the case where the number average molecular weight is at least 5000, the viscosity of the ink increases, and stability in the ink jet tends to be low.

Other than the above, a drying retardant, antiseptics and water-soluble coloring agents etc can be added, if necessary, to the fiber discharging ink and the fiber discharge inhibiting ink.

The fiber discharging ink and the fiber discharge inhibiting ink are imparted to the fabric by the ink jet system. Namely, the preparation process of a fabric forming a three-dimensional pattern comprises a step of imparting an ink containing alkaline fiber discharging agent to the fabric in a fiber discharging area by means of an ink jet system, and a step of imparting an ink containing salt of which pH is 3.0 to 8.0 when dissolved into water to an area excluding said fiber discharging area by means of the ink jet system.

By employing the ink jet system, depth and width of the unevenness can be adjusted freely. Also, meticulous three-dimensional patterns at 1 pixel level can be expressed freely without restriction of pattern such as printing mold. Further, since the depth of the unevenness can be gradually changed, in addition to an expression area where conventional roll and screen can be used, expressing a pattern of gradation with unevenness is possible. Also, the ink jet system can be considered excellent with respect to environments compared with conventional systems since a great amount of waste water are not produced, in addition to time consumption, cost and workability.

Also, the fiber discharging ink is imparted to an area where fiber discharge is carried out and the fiber discharge inhibiting ink is imparted to the other area where fiber discharge is not carried out, consequently, even though the fiber discharging ink runs down the fiber and generates blur on the fabric, fiber discharging has no effect by the fiber discharge inhibiting agent. This is because discharge behavior by the fiber discharge ink is in progress in a step of heat treatment described later, at that time, acid substances and acid ions which neutralize alkali contained in the fiber discharging ink are provided from the fiber discharge inhibiting ink. Due to the reason, it becomes possible to form a fine three-dimensional pattern whose unevenness pattern is clear since an processed area of fiber discharge and its peripheral unprocessed area of fiber discharge are clearly separated.

Also, as described above, the fiber discharging ink and the fiber discharge inhibiting ink may be imparted on a fabric before a step of heat treatment, and the order of the ink imparting step is not particularly limited. After the step of imparting the fiber discharging ink to an area of fiber discharging by the ink jet system, a step of imparting the fiber discharge inhibiting ink to an area excluding the area of fiber discharging by the ink jet system may be carried out or its converse order may be carried out. Also, those steps may be conducted at the same time. Among those, it is preferable to conduct the step of imparting the fiber discharging ink and the step of imparting the fiber discharge inhibiting ink at the same time in a viewpoint that an imparted area of the fiber discharging ink and the fiber discharge inhibiting ink can be controlled more precisely. Specifically, it is preferable to prepare an ink set equipped with the fiber discharging ink and the fiber discharge inhibiting ink and print by selecting an ink suitably according to with or without unevenness.

An amount of imparting the above described fiber discharging ink is preferably in the range of 1 to 50 g/m², and more preferably in the range of 5 to 30 g/m². When the amount is less than 1 g/m², efficient effect of unevenness tends not be obtained, and when more than 50 g/m², the cost tends to be expensive since the amount is more than necessity.

An amount of imparting the above described fiber discharge inhibiting ink is preferably in the range of 1 to 30 g/m², and more preferably in the range of 10 to 20 g/m². When the amount is less than 1 g/m², sufficient effect of fiber discharging inhibition tends not be obtained, and when more than 30 g/m², the cost tends to be expensive since the amount is more than necessity.

The fiber discharge inhibiting ink is preferable to impart to the whole area excluding an unprocessed area of fiber discharging (hereafter, it may be referred to as an area without fiber discharging). When the imparting amount is suppressed, it is preferable to impart to an area having a width of at least 3 mm toward the side of an unprocessed area of fiber discharging from the entire border between the area of fiber discharging and the area without fiber discharging. Also, when a coloring agent is imparted to as described later, at imparting an coloring agent to an area without fiber discharging, it is preferable to impart the coloring agent to the whole imparted area. The degree changes depending on coloring agents in use and a concentration used, since difference in a concentration of a coloring agent occurs due to with or without fiber discharge inhibiting ink. When an imparting amount is suppressed, it is preferable to impart to an area having a width of at least 5 mm toward the side of an unprocessed area of fiber discharging from the entire border between the area of fiber discharging and the area without fiber discharging.

Also, it is preferable to comprise a step of further imparting an ink containing a coloring agent (hereinafter referred to as a coloring ink) by the ink jet system in a viewpoint that more various expression of patterns becomes possible. The coloring ink may be selected according to a kind of a fiber which is colored.

For example, as a coloring ink for polyester fibers, an ink excellent in toughness, sharpness and developing properties, in which a dispersing dye is dispersed in water, can be mainly used. A kind of a dispersing dye is not particularly limited, but a dye matrix is a matrix having a structure of anthraquinones, azos, or quinophthalons. Other than the above, when using an ink wherein a pigment is dispersed into water or cation dyeable polyester fiber, an ink wherein a cation dye is dissolved or dispersed into water can be used.

As an coloring ink of nylon fibers, an ink wherein reactive dyes, acid dyes or metal complex dye is dissolved into water is possible to use. A kind of reactive dyes preferably has at least one kind of a reactive group selecting from a group consisting of monochlorotriazine group, monoflorotriazine group, difloromonochloropyrimidine group, trichloropyrimidine group. Reactive dyes having the other reactive groups easily cause hydrolysis under an alkali atmosphere when mixed with an ink containing alkali fiber discharging agent on a fabric, the reactive group decomposes and a coloring concentration toward other kinds of fiber has a high possibility to be lowered.

As a coloring ink for a cotton fiber, an ink wherein reactive dyes, acid dyes or metal complex dyes is dissolved into water is possible to use.

Since, for example, the effect of protecting dyes having diazo structure, wherein the dye matrix is destroyed by the alkali fiber discharging agent and color change or degradation easily occurs, is obtained by the fiber discharge inhibiting agent, these dyes can be used.

The above described ink is an ink set dissolved or dispersed into water with various colors at various concentration standards, and is suitably selected and used according to hues and concentration of a part of a pattern suitably to use. Therefore, colors are not particularly limited. An ink set equipped with at least four colors which are the three elementary colors of yellow, magenta and cyan and, additionally, black is general, but is not particularly limited. In the same manner, an amount of a dye for coloring is not particularly limited, but is preferably 0.1 to 25% by weight based on a coloring ink, considering practicability, storage stability and discharging stability. When the amount of the dye is less than 0.1% by weight, the coloring ink has no effect since a concentration of the coloring ink is too low depending on a concentration of a base color. When more than 25% by weight, discharging stability tends to be inferior since an ink has high viscosity and solubility becomes poor.

An imparting amount thereof is not particularly limited, but is preferably 1 to 50 g/m², and more preferably 5 to 30 g/m². When an amount is less than 1 g/m², possibility for a defect of thin spot tends to become high, and when an amount is more than 50 g/m², images tend to be unclear by occurring blur.

The coloring ink can comprise an antidrying agent, an antiseptic, a viscosity modifier and an ultraviolet ray absorbent, if necessary.

Also, the coloring ink may be imparted on a fabric before a step of heat treatment, and the order of the ink imparting step is not particularly limited. After the step of imparting the fiber discharging ink to the fiber discharge processing area by the ink jet system, a step of imparting the coloring ink may be carried out or its converse order may be carried out. Also, those steps may be conducted at the same time. Further, the order of a step of imparting the fiber discharge inhibiting ink is not limited in the same manner. Among those, it is preferable to conduct the step of imparting the fiber discharging ink, the step of imparting the fiber discharge inhibiting ink and the step of imparting the coloring ink at the same time in a viewpoint that an imparted area of the fiber discharging ink, the fiber discharge inhibiting ink and a coloring ink can be controlled more precisely. Specifically, it is preferable to prepare an ink set equipped with the fiber discharging ink, the fiber discharge inhibiting ink and a coloring ink and print by selecting an ink suitably according to with or without unevenness, a hue of unevenness patterns and concentration. In addition, when printing on a composite fabric, more various expression of patterns becomes possible by using a coloring agent capable of coloring various fibers.

When the fiber discharging agent is decomposed with heat and a reactive dye as an ink for coloring is used, an ink jet printing device used in the present invention is not particularly limited, as long as the device has a system without heating an ink for preventing a reactive group of reactive dyes from hydrolyzing with heat. Examples are continuous type device such as the charged modulation type, the charged injecting type, the micro dot type and the ink mist type and on-demand type devices such as the piezo conversion type and the electrostatic suction type. Among those, the piezo system is preferable in viewpoints of excellent in stability of an ink discharging amount and continuous discharging, and capable of manufacturing at a relatively low cost.

Herein, before a step of imparting the fiber discharging ink etc on a fabric by the ink jet system, it is preferable to comprise a step of forming a ink receiving layer on the fabric. The ink receiving layer formed by the steps receives an ink jetted from a nozzle instantly and maintain an ink jetted suitably, thus, blur of the fiber discharge ink etc is prevented and a clearer three-dimensional pattern can be obtained.

The ink receiving layer is generally formed by an ink receiver in which a water soluble polymer is a main component. Examples of the water soluble polymer are sodium alginate, methyl cellulose, hydroxymethyl cellulose, carboxymethyl cellulose, starch, guar gum, polyvinyl alcohol, and polyacrylic acid. These can be used in a combination of at least two kinds. Among those, carboxymethyl cellulose excellent in chemical resistance and alkali resistance, low cost and flowability is preferable. An ink receiving layer can contain an reduction inhibitor, a surfactant, an antiseptic and a light resistance improving agent, if necessity.

The ink receiving agent is preferably imparted in an amount of 1 to 20 g/m² with a solid content conversion, and more preferably 2 to 10 g/m². When an imparting amount is less than 1 g/m², the ink tends to blur or transfer to the back side since ability to receive an ink is inferior. When more than 20 g/m², there is a tendency that conveying properties in an ink jet printer becomes inferior and a receiving agent easily drops out from a fabric when dealing with it since the fabric becomes hard.

Examples of imparting methods are a dip nip method, a rotary screen method, a knife coater method, a kiss roll coater method and a gravure roll coater method. Among those, a dip nip method is preferable in viewpoints that an ink receiving layer can be imparted on not only the surface of the fabric but also the entire fabric and a fabric excellent in ink receiving layer can be prepared.

A fiber discharging ink, a fiber discharge inhibiting ink and, if necessary, a coloring ink are imparted by the ink jet system, and then, a treatment with heat is carried out. A fiber is discharged by a treatment with heat and an unevenness appears, and in case of imparting a coloring ink, the fabric is colored.

As for conditions of heat treatment, it is preferable to treat at 160 to 190° C. for about 10 minutes. When a temperature is less than 160° C., there is tendency that discharge is insufficient and coloring to particularly a polyester fiber is insufficient. When a temperature is more than 190° C., a phenomenon such as change into yellow due to burning a fiber easily occurs, also, when using a nylon fiber, its coloring tends to be insufficient, adversely. Heat treatment may be either dry heat treatment or wet heat treatment. Among those, it is preferable to treat with wet heat treatment in viewpoints that a shape of unevenness which is formed becomes excellent, and excellent color development can be obtained as well in case of coloring at the same time.

Further, it is preferable to conduct washing treatment for the purpose of dropping an ink receiving layer remained on the fabric, an unadhered dye, and further a decomposed article of a fiber from a fabric after heat treatment. As for a method of this washing treatment, a generally conducted reduction clearing using hydrosulphite, a surfactant, a soda ash and the like is employed.

Further, it is preferable to carry out caustic treatment at the reduction clearing.

A fiber remained to be fluff because of insufficient fiber decomposition can be removed by carrying out a caustic treatment and thus it becomes possible to form more clear unevenness. A loss in weight accelerator such as a cation surfactant, an alkali penetrant, and a strong alkali agent such as caustic soda are employed for a caustic treatment.

Conditions of a caustic treatment are not particularly limited, but an example is using a loss in weight accelerator in an amount of 1 to 5 g/L and a caustic soda (granulated powder) in an amount of 2 to 15 g/L, and treating at a treatment temperature of 70 to 90° C. for 10 to 60 minutes.

As a loss in weight accelerator, examples such as an aliphatic amine salt cation surfactant, a quaternary ammonium salt cation surfactant of an aliphatic amine salt, an aromatic quaternary ammonium salt cation surfactant and a heterocyclic quaternary ammonium cation surfactant can be used.

In this manner, a fiber is completely removed by the washing treatment and/or the caustic treatment.

### EXAMPLES

Examples are shown in the following. Note that % used in Examples indicates a ratio of the weight standard.

### Preparation Example 1

(Preparation of Fabric A)

A composite fabric (reversible (tricot half) fabric of warp knitting) having a thickness of 2 mm, which is constituted with one surface side (printing surface) of a polyester fiber (66dtex/144f, available from Toray Industries. Inc.) and a back side of 6nylon (78dtex/24f, available from Toray Industries. Inc.) was imparted with a treated solution obtained by mixing the following composition and agitating for 1 hour by using a homogenizer to have 2 g/m2 at the solid content conversion by the Dip Nip method, and a composite fabric A in which an ink receiving layer was formed was obtained by drying for 2 minutes at 170° C.

Ink receiving layer-forming treatment solution

| | |
|---|---|
| DKS Fine Gum HEL-1 | 2% |
| (available from DAI-ICHI KOGYO SEIYAKU CO., LTD. | |
| etherificated carboxymethyl cellulose) | |
| MS liquid | 5% |
| (available from Meisei Chemical Works, Ltd., nitrobenzene | |
| sulfonate, a reduction inhibitor, 30% of an active component) | |
| Water | 93% |

### Preparation Example 2

(Preparation of Fabric B)

An ink receiving layer was formed on a composite fabric (dappled fabric of circular knitting by the plating method) having a thickness of 2 mm, which is constituted with a one surface side (printing surface) of a cation dyeable polyester fiber (available from Toray Industries. Inc., 84dtex/72f) and a back surface side of 6nylon (available from Toray Industries. Inc., 78dtex/24f) to obtain a composite fabric B in the same manner as Preparation Example 1.

### Preparation Example 3

(Preparation of Fabric C)

An ink receiving layer was formed on a pile fabric having a thickness of 3 mm, which is constituted with a polyester fiber (available from Toray Industries. Inc., 66dtex/144f) to obtain a composite fabric C in the same manner as Preparation Example 1.

### Preparation Example 4

(Preparation of PET Fibers Discharging Ink a-1)

The following compositions were mixed respectively, the mixture was depressurized and filtered through an ADVANTEC high-purification filter paper No. 5A (available from Toyoroshi Kabusikikaisya) after agitating for 1 hour by using a stirrer. Then, PET fiber discharging ink a-1 (3 cps of viscosity at 25° C.) was obtained by vacuum deaeration treatment. Also, pH of an aqueous solution of 20% of guanidine carbonate is 12.

PET fiber discharging ink a-1

| | |
|---|---|
| Guanidine carbonate (PET fibers discharging agent) | 20% |
| Urea (dissolution stabilizer) | 5% |
| Diethyleneglycol (drying inhibitor) | 5% |
| Water | 70% |

### Preparation Example 5

(Preparation of PET Fiber Discharging Ink a-2)

The following compositions were mixed respectively, the mixture was depressurized and filtered through an ADVANTEC high-purification filter paper No. 5A (available form Toyoroshi Kabusikikaisya) after agitating for 1 hour by using a stirrer. Then, PET fiber discharging ink a-2 (2 cps of viscosity at 25° C.) was obtained by vacuum deaeration treatment. Also, pH of an aqueous solution of 20% of sodium hydroxide is 14.

PET fiber discharging ink a-2

| | |
|---|---|
| Sodium hydroxide (PET fiber discharging agent) | 10% |
| Urea | 5% |
| Water | 85% |

### Preparation Example 6

(Preparation of PET Fiber Discharge Inhibiting Ink b-1)

The following compositions were mixed respectively, the mixture was depressurized and filtered through an ADVANTEC high-purification filter paper No. 5A (available form Touyoroshi Kabusikikaisya) after agitating for 1 hour by using a stirrer. Then, PET fiber discharge inhibiting ink b-1 (pH of 5.0, 3 cps of viscosity at 25° C.) was obtained by vacuum deaeration treatment. Also, pH of an aqueous solution of 40% of ammonium sulphate is 4.5.

PET fiber discharge inhibiting ink b-1

| | |
|---|---|
| Ammonium sulphate (discharge inhibitor) | 40% |
| Urea (dissolution stabilizer) | 5% |
| Diethyleneglycol (drying inhibitor) | 5% |
| Water | 50% |

### Preparation Example 7

(Preparation of PET Fiber Discharge Inhibiting Ink b-2)

The following compositions were mixed respectively, the mixture was depressurized and filtered through an ADVANTEC high-purification filter paper No. 5A (available form Toyoroshi Kabusikikaisya) after agitating for 1 hour by using a stirrer. Then, PET fiber discharge inhibiting ink b-2 (pH of 8.0, 3 cps of viscosity at 25° C.) was obtained by vacuum deaeration treatment. Also, pH of an aqueous solution of 15% of magnesium sulphate is 7.5.

PET fiber discharge inhbiting ink b-2

| | |
|---|---|
| Magnesium sulphate (discharge inhibitor) | 15% |
| Urea (dissolution stabilizer) | 5% |
| Diethyleneglycol (drying inhibitor) | 5% |
| Water | 75% |

### Preparation Example 8

(Preparation of an Ink Set of the Three Elementary Color for PET Fiber Coloring c)

The following compositions were mixed respectively, the mixture was depressurized and filtered through an ADVANTEC high-purification filter paper No. 5A (available form Toyoroshi Kabusikikaisya) after agitating for 1 hour by using a stirrer. Then, an ink set of the three elementary color for PET fiber coloring was obtained by vacuum deaeration treatment.

Ink set of the three elementary color for PET fiber coloring c
(Blue ink)

| | |
|---|---|
| Kiwalon Polyester Blue BGF | 10% |
| (Dispersion dye, C.I. Disperse Blue 73, available from KIWA | |
| CHEMICAL INDUSTRY CO., LTD.) | |
| Disper TL (dye dispersing agent, available from Meisei | 2% |
| Chemical Works, Ltd.) | |
| Diethyleneglycol (drying inhibitor) | 5% |
| Water | 83% |

(Red ink)

| | |
|---|---|
| Kiwalon Polyester Red BFL | 10% |
| (Dispersion dye, C.I. Disperse Red 92, available from KIWA | |
| CHEMICAL INDUSTRY CO., LTD.) | |
| Disper TL (dye dispersing agent, available from Meisei | 2% |
| Chemical Works, Ltd.) | |
| Diethyleneglycol (drying inhibitor) | 5% |
| Water | 83% |

(Yellow ink)

| | |
|---|---|
| Kiwalon Polyester Yellow 6GF | 10% |
| (Dispersion dye, C.I. Disperse Yellow 114, available from KIWA | |
| CHEMICAL INDUSTRY CO., LTD) | |
| Disper TL (dye dispersing agent, available from Meisei | 2% |
| Chemical Works, Ltd.) | |
| Diethyleneglycol (drying inhibitor) | 5% |
| Water | 83% |

### Example 1

The fiber discharging ink a-1 obtained in Preparation Example 4, the fiber discharge inhibiting ink b-2 obtained in Preparation Example 6 and the ink set for coloring c obtained in Preparation Example 8 were printed out on fabrics A, B and C having the ink receiving layer obtained in Preparation Examples 1 to 3 by the ink jet system.

Herein, printing was conducted as shown in Drawing 1, assuming that an area of PET fiber discharging is area X, an area without PET fiber discharging (non-colored area) is area Y, and an area without PET fiber discharging (area of PET fiber color pattern coloring) is area Z. Namely, a circle 3 having 10 mm of a diameter and a square 4 having 5 mm of a side length were drawn from the center of a rectangle 2 of 25 mm long and 40 mm wide, and an area enclosed with the circle 3 and the square 4 is an area X, an area of the left side of line connecting center points of long sides of the rectangle 2 and not containing the area X is area Y, and an area of the right side of line connecting center points of long sides of the rectangle 2 and not containing the area X is area Z. It is sure that effects by the preparation process of the present invention are not limited to this printing pattern.

Conditions for ink jet printing at this time are shown in the following.

Conditions for ink jet printing

| | |
|---|---|
| Printing device: | on-demand type serial scanning |
| | ink jet printing device |
| Nozzle diameter: | 50 μm |
| Driving voltage: | 100 V |
| Frequency: | 5 kHz |
| Resolution: | 360 dpi |
| Printing amount: | (1) Area X (an area of PET fiber discharging) |
| | PET fiber discharging ink 40 g/m² |
| | (2) Area Y (an area without PET fiber discharging) |
| | PET fiber discharge inhibiting ink 10 g/m² |
| | (3) Area Z (an area without PET fiber discharging |
| | and an area of PET fiber color pattern coloring) |
| | PET fiber discharge inhibiting ink 10 g/m² |
| | Ink set of the three elementary colors for PET |
| | fiber coloring 15 g/m² of each color |

Wet heat treatment was conducted at 170° C. for 10 minutes by using a HT steamer after drying a fabric. Further, a printed matter was obtained by water washing and drying after treating in a soaping bath containing 2 g/L of a TRIPOL TK (nonion surfactant, available from DAI-ICHI KOGYO SEIYAKU CO., LTD), 2 g/L of a soda ash and 1 g/L of hydrosulphite at 80° C. for 10 minutes.

### Example 2

A fiber discharging ink a-1, a fiber discharge inhibiting ink b-2, and an ink set for coloring c were printed on fabrics A, B and C to obtain printed matters in the same manner as Example 1.

### Example 3

A fiber discharging ink a-2, a fiber discharge inhibiting ink b-1, and an ink set for coloring c were printed on fabrics A, B and C to obtain printed matters in the same manner as Example 1

### Example 4

A fiber discharging ink a-2, a fiber discharge inhibiting ink b-2, and an ink set for coloring c were printed on fabrics A, B and C to obtain printed matters in the same manner as Example 1.

### Comparative Example 1

A fiber discharging ink a-1 and an ink set for coloring c were printed on fabrics A, B and C to obtain printed matters in the same manner as Example 1 except that a fiber discharge inhibiting ink b-1 is not used. Conditions for ink jet printing at this time are shown in the following. Herein, printing was not carried out on an area corresponding to the area Y, and only a coloring ink was printed on an area corresponding to the area Z.

Conditions for ink jet printing

| | |
|---|---|
| Printing device: | on-demand type serial scanning ink |
| | jet printing device |
| Nozzle diameter: | 50 μm |
| Driving voltage: | 100 V |
| Frequency: | 5 kHz |
| Resolution: | 360 dpi |
| Printing amount: | (1) Area X (an area of PET fiber discharging) |
| | PET fiber discharging ink 40 g/m² |
| | (2) Area corresponding to area Y (an area without |
| | PET fiber discharging) |
| | not printed |
| | (3) Area corresponding to area Z (an area without |
| | PET fiber discharging and an area of PET fiber |
| | color pattern coloring) |
| | Ink set of the three elementary colors for PET |
| | fiber coloring 15 g/m² of each color |

### Comparative Example 2

A printed matter was obtained in the same manner as Comparative Example 1 except for using a-2 as a fiber discharging ink.

Printed matters obtained in the above described Examples 1 to 4 and Comparative Examples 1 to 2 were evaluated by the following 2 items. The results are shown in Table 1.

(1) Unevenness Sharpness on a Border of Area X and Area Y and a Border of Area X and Area Z

The sharpness of borders of each area were visually judged by using a magnifier according to the following standard.

⊚ A border is extremely sharp

◯ A border is sharp

Δ A border is somewhat blur

X A border is blur

(2) Clarity, Depth of a Color Pattern on the a Border of Area X and Area Z and a Border of Area Y and Area Z

The clarity of the color pattern was visually measured, and as for the depth, a reflection density was measured by using a Macbeth RD918 (made by Gretag Macbeth), and the clarity and the depth were comprehensively judged according to the following standard.

⊚ A border is extremely clear and color patterns appear with deep colors

◯ A border is clear and color patterns appear with deep colors

Δ A border is somewhat blur and color patterns appear with color depth defect

X A border is blur and color patterns appear with color depth defect

TABLE 1

| | Ex. 1 | | | Ex. 2 | | | Ex. 3 | | | Ex. 4 | | | Com. Ex. 1 | | | Com. Ex. 2 | | |
|---|---|---|---|---|---|---|---|---|---|---|---|---|---|---|---|---|---|---|
| Fiber discharging ink | a-1 | | | a-1 | | | a-2 | | | a-2 | | | a-1 | | | a-2 | | |
| Fiber discharge | b-1 | | | b-2 | | | b-1 | | | b-2 | | | — | | | — | | |
| inhibiting ink | | | | | | | | | | | | | | | | | | |
| Fabric | A | B | C | A | B | C | A | B | C | A | B | C | A | B | C | A | B | C |
| Unevenness | | | | | | | | | | | | | | | | | | |
| Sharpness | | | | | | | | | | | | | | | | | | |
| Border of areas X and Y | ⊚ | ⊚ | ⊚ | ◯ | ◯ | ◯ | ◯ | ◯ | ◯ | Δ | Δ | Δ | Δ | Δ | Δ | Δ | Δ | Δ |
| Border of areas X and Z | ⊚ | ⊚ | ⊚ | ◯ | ◯ | ◯ | Δ | Δ | ◯ | Δ | Δ | Δ | X | X | Δ | X | X | Δ |
| Expression of color | | | | | | | | | | | | | | | | | | |
| patterns | | | | | | | | | | | | | | | | | | |
| Border of areas X and Z | ⊚ | ⊚ | ⊚ | ◯ | ◯ | ◯ | Δ | Δ | ◯ | Δ | Δ | Δ | X | X | Δ | X | X | Δ |
| Border of areas Y and Z | ⊚ | ⊚ | ⊚ | ⊚ | ⊚ | ⊚ | ⊚ | ⊚ | ⊚ | ⊚ | ⊚ | ⊚ | ⊚ | ⊚ | ⊚ | ⊚ | ⊚ | ⊚ |

Examples 1 and 2 in which the fiber discharging ink a-1 is used are excellent in both sharpness of an unevenness border and color pattern expression of the unevenness border, and particularly Example 1 has extremely high superiority. Examples 3 and 4 in which the fiber discharging ink a-2 is used are somewhat inferior to Examples 1 to 2, but results superior to Comparative Examples can be obtained.

As for fabrics A and B in which blur of an ink easily occurs particularly in a direction of a fiber, Examples are shown to have extremely high superiority compared with Comparative Examples in terms of both sharpness of the unevenness border and color patterns of the unevenness border.

What is claimed is:

1. A preparation process of a fabric forming a three-dimensional pattern comprising a step of imparting an ink containing alkaline fiber discharging agent in a fiber discharged area on a fabric by an ink jet system, and a step of imparting an ink containing salt of which pH is 3.0 to 8.0 when dissolved into water to an area excluding said fiber discharged area by the ink jet system.

2. The preparation process of the fabric forming a three-dimensional pattern of claim 1, further comprising a step of imparting an ink containing a coloring agent by the ink jet system.

3. The preparation process of the fabric forming a three-dimensional pattern of claim 1, wherein said alkaline fiber discharging agent is guanidine carbonate

4. The preparation process of the fabric forming a three-dimensional pattern of claim 1, wherein said fabric comprises polyester fibers.

5. The fabric forming a three-dimensional pattern, which is obtained by the process of claim 1.
